(19) United States
(12) Patent Application Publication
(10) Pub. No.: US 2026/0111630 A1
(43) Pub. Date: Apr. 23, 2026

(54) 3D Soft Surface Decorative Article Simulator

(71) Applicant: Shaw Industries Group, Inc., Dalton, GA (US)

(72) Inventors: Aernout Raphael Hetem, Soddy Daisy, TN (US); Patrick J. Harris, Dalton, GA (US); Luke Joseph Armitage, Chattanooga, TN (US)

(21) Appl. No.: 19/476,521

(22) PCT Filed: Oct. 17, 2024
(86) PCT No.: PCT/US2024/051732

§ 371 Date: Oct. 17, 2025

Related U.S. Application Data
(60) Provisional application No. 63/590,799, filed on Oct. 17, 2023.

(51) Int. Cl. G06F 30/20; G06F 113/12; G06T 19/20

(52) U.S. Cl. CPC G06F 30/20; G06T 19/20; G06F 2113/12; G06T 2210/16

(57) ABSTRACT

A method is described for simulating a carpet in three dimensions. Properties of yarn to be used in the carpet are compiled. A carpet is designed with selections of desired placement of tufts of yarn and desired yarn properties. A descriptor file is created using the design of the carpet and including the properties of yarn. The descriptor file may include also the type of simulation model used to simulate the carpet pile in addition to other information such as how the carpet simulation is to be displayed. After the descriptor file is created, it is submitted to a rendering engine which calculates the appearance of and displays the simulated carpet to a user. In an embodiment, the pile for each tuft of yarn may be randomized between a minimum height and a maximum height or each filament of a yarn tuft may be so randomized.

### BACKGROUND OF THE INVENTION

The present invention relates to simulating soft surface decorative articles in three dimensions.

Soft surface decorative articles are inherently three-dimensional (3D) objects. Existing simulations of soft surface decorative articles have been limited to two dimensional (2D) simulations that do not take into account the inherent differences in the materials used in the soft surface decorative articles, nor in the variation in the output of the machines used to manufacture said articles. In addition, 2D simulations cannot take into account the look and feel of the soft surface decorative article when illuminated under different types of light.

Accordingly, a need arises for techniques that can simulate the look and feel of a soft surface decorative article in all three dimensions.

### SUMMARY OF THE INVENTION

Aspects of the disclosure relate to systems and methods for simulating soft surface decorative articles in three dimensions.

In one aspect, a method for simulating a soft surface decorative article such as a carpet in three dimensions comprises several steps. The method comprises receiving parameters for modeling of a yarn. Then the method comprises modeling a tuft of the yarn using the received parameters. A descriptor file for a carpet is created based on the modeled tuft of yarn. The descriptor file is submitted to a rendering engine which displays the simulated carpet.

The rendering engine may be Blender. The method for simulating carpet may further comprise simulating a plurality of yarns based on a yarn texture, a yarn color, a pile height, a pile type, or a user preference. The pile heights of different filaments of a yarn tuft may be randomly distributed between a minimum height and a maximum height. The yarn may be multi-ply yarn. The descriptor file may comprise selection of a model and model parameters from Blender.

The model may comprise a parent and children model for filament modeling. Parent and child/children filaments is one method to reduce the computational cost of simulating many filaments. The software calculates how the parent filament will act/react/move and then has the children filaments mimic the same motions. So for calculating a single solution to a set of complicated equations, you can simulate the operation of many filaments at roughly 1/50th of the computational requirements. The children filaments of the parent filament may mimic the parent's modeled behavior but may be displaced in an X direction and in a Y direction from the parent filament.

In another aspect, the soft surface decorative article may be a simulated turf. The simulated turf comprises simulated blades of grass and simulated pieces of thatch. The simulated blades of grass may have constraints on bend angles and the simulated pieces of thatch may have no constraints on bend angles. The simulated pieces of thatch may bend along an axis parallel to a length of the thatch and the simulated pieces of thatch may also bend along an axis perpendicular to the length of the thatch. The simulated blades of grass may bend only along an axis perpendicular to the length of the blade of grass.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and the invention may admit to other equally effective embodiments.

FIG. 1 illustrates an isometric view of a 3D simulation of a carpet section.

FIG. 2 illustrates a flow chart of an embodiment of the method.

FIG. 3 illustrates an exemplary process of simulating cut pile and loop pile carpet.

FIG. 4 illustrates a simulated carpet with both cut pile and loop pile.

FIG. 5 illustrates a 3D simulation of carpet under two different types of illumination.

FIG. 6 illustrates an exemplary process of simulating blades of grass.

FIG. 7 illustrates an exemplary process of simulating thatch.

FIG. 8 illustrates a 3D simulation of turf under two different types of illumination.

FIG. 9 illustrates a computing device on which the method may be performed.

FIG. 10 illustrates a system for producing a 3D simulation of a soft surface according to an aspect of the current disclosure.

Other features of the present embodiments will be apparent from the Detailed Description that follows.

### DETAILED DESCRIPTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention. Electrical, mechanical, logical, and structural changes may be made to the embodiments without departing from the spirit and scope of the present teachings. The following detailed description is therefore not to be taken in a limiting sense, and the scope of the present disclosure is defined by the appended claims and their equivalents.

The present disclosure relates to simulating soft surface decorative articles such as, but not limited to, tufted carpets or turf.

Simulating the appearance of a carpet relies not just on the two-dimensional (2D) placement of yarn with color and pile type, but on a deeper understanding of the mechanical and the optical properties of the yarn. While a file has been used in the past for instructing where an automated tufting machine should place each type of yarn, these files do not take into account the inherent differences in the yarn itself, nor in the variation in the output of the tufting machine in placement and yarn length.

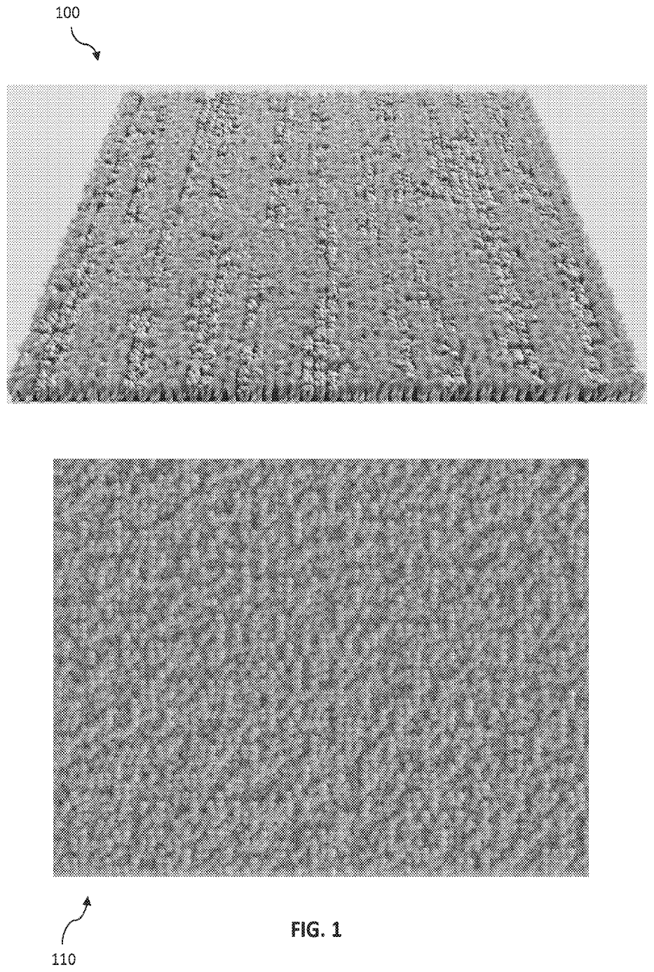

Bitmap files can be used to create a 2D display of a design, but such files do not convey the richness of the 3D effects possible with a carpet. For instance, normal variation in the height of the pile will produce shading effects as shown in FIG. 1, which includes simulation of height variation in the pile of a carpet. FIG. 1 shows a carpet of mixed loop and cut pile 100 in an isometric view and also a carpet simulation of cut pile only 110 in top-down view. Both carpet simulations illustrate the variation in the height of the pile as well as the differences in the type of pile (cut vs. loop) which lead to differences in shadows cast and light reflected by each tuft. Such minute differences in height are nearly impossible to capture in a 2D simulation. These variations in pile height may in some instances be an intentional part of the design of the carpet, but are inherently part of what makes carpet appealing to look at and to feel. In addition, all real-world tufting machines have some variation in the heights of the pile as well as some variation in the placement of the tufts.

Tufting machines tuft yarns through a backing material with the help of mechanical or electronically driven cams and servo-motors. There is a limit to the accuracy with which the tufts may be placed on the backing in addition to variation in the heights of the pile achieved. This variation is not regular and may be driven by an intentional graphic design or may be the result of the inherent variation in the programmatically controlled cams and servo-motors. It is laborious to simulate these electronic and mechanical movements and the variation in pile heights. Thus creating a full 3D simulation of tufted goods is a complex and difficult problem to solve. A full 3D simulation takes into account interactions with every fiber in the entire carpet. By keeping track of each pile with one, two or a few parent filaments, the number of filaments can be reduced by a factor of 50 or more. Instead of 100 fibers per pile, 2 (or a few) fibers per pile are simulated and the remaining other 98 fibers mimic the parent with minor modifications, like length and slightly different separations between the parent the different children. Automated tufting machines may receive as input a set of instructions in a machine file, often proprietary or machine-specific, which includes features of the carpet which can be controlled by the tufting machine, such as location of the tufts, which yarn to use at each location, the type of pile (loop or cut), and the nominal height of the pile at each location. The machine file, however, does not necessarily provide the inherent variations in placement and pile height, nor does it take into account any of the yarn's inherent characteristics such as color, material strength, plasticity, ductility, etc. Thus, creating a machine file by itself for the single purpose of yarn placement and pile height does not enable 3D rendering software (e.g. Blender's render engine) to be used to accurately simulate the 3D appearance of a carpet without additional human intervention.

While the machine file typically gives the automatic tufting machine information about which yarn to use, it does not necessarily include information about the appearance of the carpet. To understand how the carpet will appear in three dimensions requires additional information regarding various factors & characteristics of the yarns/blade/fibers that make up the carpet that may not be included in the machine file. For example, a machine file may instruct a tufting machine to move the needle blade to certain locations and to move certain motors at certain times, but may contain no information about the type and color of the yarn being used. The machine file may, for instance, only contain instructions to advance a particular servo-motor at a certain time. The additional information includes, but is not limited to, the color of the yarn, the texture of the yarn, the yarn's material characteristics, and also how the individual piles interact with each other. In principle it is possible to model every individual strand making up each piece of yarn, but this requires significant computing resources as the carpet increases in area. To understand how the pieces of yarn interact requires an understanding of the yarn's material properties, such as the yarn density, the Young's modulus and the stress-strain curve, which in turn depend on the type of material used for the yarn (e.g. polyester, wool, etc.) as well as the pile height (tall pile will fall over but short pile will stand up straight), and other characteristics.

From an original carpet design—basically a file comprising the nominal location of each tuft, with the type of yarn for each tuft—two additional files may be created. A machine file may be created from the carpet design. The machine file will be read by an automated tufting machine, but may include proprietary data or instructions specific to a particular tufting machine. Thus a machine file may include instructions to servo-motors to move a needle bar and to use a particular type of yarn for certain sections of the carpet. The machine file may also comprise instructions on the tension of the backing material or the motion of the backing material during the fabrication of the actual carpet. Separately from the machine file, a descriptor file can also be made from the design of the carpet (e.g., from a bitmap file). This descriptor file may include instructions for which model of filament simulation is to be used as well as details on the variability of the placement of the tufts, the type of tufts, and also the variations selected for such parameters as filament length for parent and for child filaments, maximum filament length, minimum filament length, distribution of filament lengths between the maximum and minimum values, number of bend angles (e.g., for a blade of grass or for a piece of thatch), constraints on the bend angles, variation in width, or other parameters desired by the user.

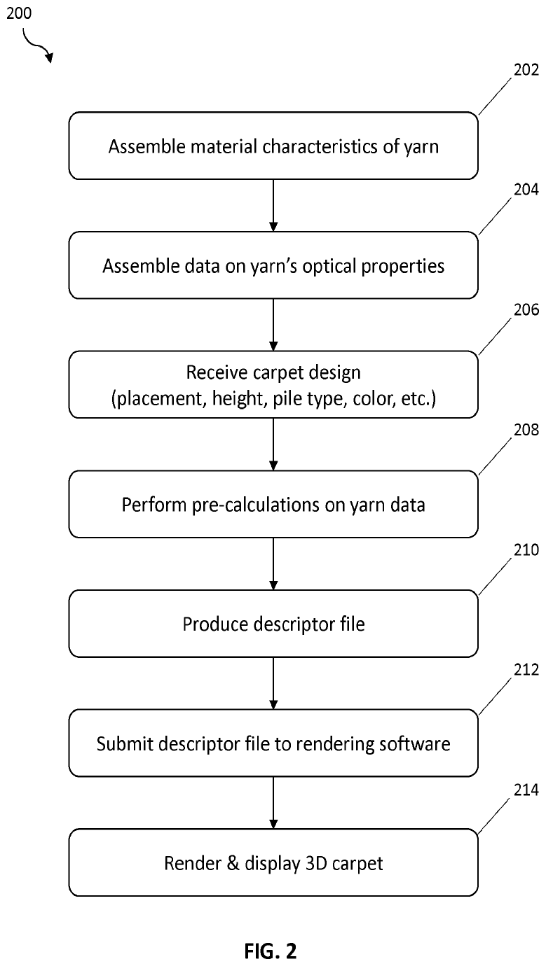

FIG. 2 shows a flow chart illustrating the method. The simulation method 200 starts with step 202, at which the material characteristics of different types of yarn are collected for reference. At step 204, the yarn's optical properties are collected, such as color, transparency, reflectiveness, scattering, and the like. Even understanding the properties of the yarn, there are imperfections such as how tightly or loosely the filaments are placed or wound together which can affect the appearance of the resulting carpet. Imperfections may be captured by addition or subtraction of random amounts of filament lengths, pile heights, displacements between filaments or between piles, and other variables.

At step 206, the method receives a carpet design which may include, for each tuft, the nominal placement location, height, pile type, yarn type, texture, and color. Once the carpet design is received at step 206, then at step 208 pre-calculations are performed on the assembled yarn data and the carpet design. These calculations result in a descriptor file at step 210. The descriptor file is then submitted to rendering software at step 212. In an example, the rendering software Blender may display the 3D simulated carpet at 214, but other rendering engines may also be used. At step 214, the rendering engine displays the 3D carpet simulation. This simulation may include the ability to display how the carpet will look under different types of illumination such as different light temperatures or light from different directions or mixtures of direct and diffuse light.

In an embodiment, the material and optical characteristics of yarns may be collected in advance. For example, the material and optical characteristics of a particular woolen yarn may depend on the sheep variety, where the sheep resided, and the post-shearing processing of the wool. In an example carpet design with high pile, the wool may stand up straight until it reaches a height of approximately 15 mm. If it is known that processing the wool differently may produce cut pile standing straight up to 20 mm, and that varying the process may cause pile as short as 10 mm to fall over, then these different yarn characteristics can be included in the 3D simulation. Similarly, if a particular polyester yarn can be manufactured with different optical properties such as varying the reflection, then these properties can be included in the type of yarn selected for a carpet's design.

Prior to production of the descriptor file at step 210, the simulation process performs pre-calculations on the yarn's properties (optical, material, mechanical, etc.). These pre-calculations determine, from the yarn's inherent properties and knowledge of the manufacturing process, the texture of the resulting yarn for simulation purposes. In an example, the user may be presented with a slider for choosing one of a number of texture options. For example, a user may be presented with a number (e.g., 16) different levels of texture or an alternative number (e.g., 10) levels of sheen. In addition, the user may select a method for simulating the yarn which balances the computer resources available with the desired level of realism in the resulting simulation. The pre-calculations determine, from the yarn database of characteristics, how to achieve the desired level of texture or sheen or other carpet property. In an example, a table of yarn properties may be used for the system to look up a desired property.

One aspect of simulated a carpet's pile is that the tufts of yarn have non-uniform lengths due to variability in the tufting process as well as variability in the filaments which make up the yarn. In an example, this variability in tuft length for pile of yarn can be simulated by applying a maximum and a minimum length of the filaments which make up the yarn and then applying a uniformly random distribution of lengths within the bounds of the maximum and minimum lengths. Other distributions of the lengths within these bounds may also be used, such as normal distribution, double peaked, and the like. A similar process can be applied to the yarn tufts themselves, assuming a uniform filament length, or, at added complexity & cost, including the distribution of filament lengths, to determine a variability of pile height which results in the individual shading evident in the carpet 110 from FIG. 1. In addition to the variability of filaments and tufts, there is also some variability in the placement of the yarn tufts in all three dimensions. A carpet is fabricated by a tufting machine by stretching a backing material, and having the tufting needles enter the backing material to place the tufts of yarn. The reproducibility of placing the tufts in precisely the right location in the X & Y directions is not perfect due to variability of the cams and motors placing the needles and the yarn. Similar methods can be used to simulate slight variations in the placement of the tufts in all three dimensions, as needed. In an embodiment, the placement of each tuft (e.g., in X & Y) would include a random element or elements (e.g., ΔX & ΔY) with some distribution from the maximum (e.g., X+ΔX/2) to the minimum (e.g., X−ΔX/2). For certain types of backing materials stretched at certain tension levels, the variation in the Z direction may be minimized and not worth including in the simulation. Similarly, for certain types of carpet, such as artificial turf, the placement in the X & Y directions is much more uniform than for throw carpets, so that for turf simulations there may be no need to include variation in the X & Y directions for the placement of each tuft. In addition, the backing material itself may move or be moved during the manufacturing process and the tension applied to the backing may vary, which also can result in variations in pile height and placement.

In an embodiment, to create the look and feel of carpet in a rendering engine, a first step is to build up a simulation of a single filament, then combine filaments to make a single ply yarn and then combine plies to make a multi-ply yarn. Once the yarn object has been created, the placement of the yarn on the backing material can be simulated and the rendering engine can display the yarn from various angles and with various forms or angles of illumination so that the user can get a better feel for how the carpet will appear in real life.

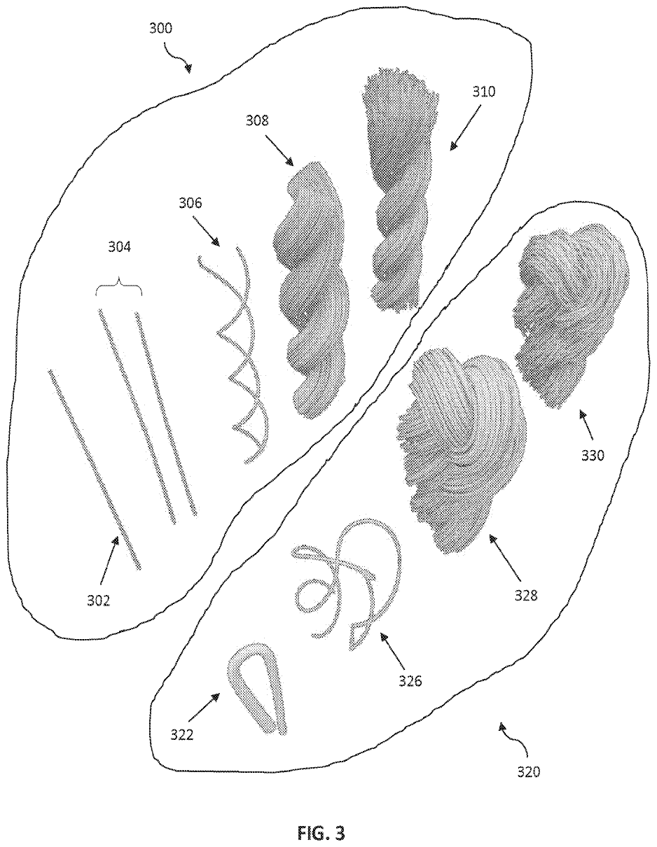

FIG. 3 illustrates an exemplary cut pile tuft simulation process 300 and also a loop pile tuft simulation process 320. The cut pile process 300 is shown in elements 302-310 and the loop pile process 320 is shown in elements 322-330. The cut pile tuft process 300 starts with defining a single filament or strand 302 then proceeding to add a second strand 304. Additional strands can also be included, if desired. These strands/filaments can be coiled or curled together 306. In an embodiment, there may be two parent filaments 304, 306, each of which may have a number of child filaments. In an embodiment, the child filaments may be offset from their parent filament in X & Y coordinates tangentially using, for example, the Euler method of calculation. Additional parent or child strands/filaments may be added as necessary. In an embodiment, the parent filaments 304, 306 may be more fully simulated and the child filaments may have their motion or stance be linked to the parent filament. Note that the method is not limited to parent and child filament simulations, but other methods such as mesh simulations, may also be employed. In an example, the method for simulating a single tuft may also be selected. In an example, a rendering engine may offer multiple options for the simulation of such multi-strand material (e.g. animal fur in animated movies) and the descriptor file may include a selected model option for simulating the carpet. One example of such a method of balancing complexity (& thus computer resources) with time is to use a parent and child approach to simulating the yarn tuft. A single parent strand is created at 302. Then a second parent strand is created at 304 which may mimic the first parent strand 302 in length and shape, but vary in location or rotation. At step 306, both strands may be coiled. This coil may be achieved by mimicking the same coil in both strands, or allowing each strand to be coiled with some small random differences, for example, in coil radius, or upward angle. In the example shown in FIG. 3, the coil 306 is approximately the same for both of the parent strands to demonstrate simulating well-formed two-ply yarn at step 308. In this example, to save on computer resources, the child strands may mimic quite closely the motion and shape of their parent strand. Again the descriptor file may, in an embodiment, include the randomness of how closely each child filament mimics its parent filament. The child strands may also be identically simulated as the parent strands, but displaced translationally in two or in three dimensions. In an example, the child strands may perfectly mimic the parent strands and therefore these parent+child strands may form a clump. In another example, the child strands may only mimic the parent strands to within 10% so that tightly bound clumps may not form at all. Again, in an example, the various filaments may have a certain amount of attraction or stickiness, and these settings could be included in the descriptor file. In practice, it may be more efficient to displace the child strands only in two dimensions and to simulate variation in filament height by randomizing the lengths of each of the child strands according to some height distribution between an upper bound and a lower bound. In the example shown in in FIG. 3, of a two ply tuft at step 308 each filament, and therefore each ply, have precisely the same length. By adding some variation in the length of the filaments and their displacement from each other, a fuzzy ended two-ply cut yarn pile 310 may be simulated. A similar process may be used to create a loop pile rather than a cut pile. The loop pile process 320 starts with forming a rough loop of a single strand 322, then coiling the strand as shown at 326. A loop pile of many strands may be simulated as at 328 with threads of precisely the same length by adding additional child filaments of the same length, but displaced in the X & Y directions and otherwise quite closely mimicking the bends of the parent filament. Adding some additional randomness with curls, kinks, and length variation amongst the filaments produces a more accurate representation of a fully formed loop pile 330. In this example, the loop pile process 320 is illustrated using a single ply yarn while the cut pile process 300 is illustrated using a two-ply yarn. It is understood that more complicated types of yarn may also be employed with the yarn varying its material parameters or its optical parameters along its length, or by using multi-ply yarn with different materials and colors for each ply of the yarn (e.g., 2 or more parent filaments with each parent filament with different properties). For simplicity in explaining this method, only one-ply and two-ply yarns have been demonstrated, but multi-ply yarn can also be simulated in a straightforward application of this technique.

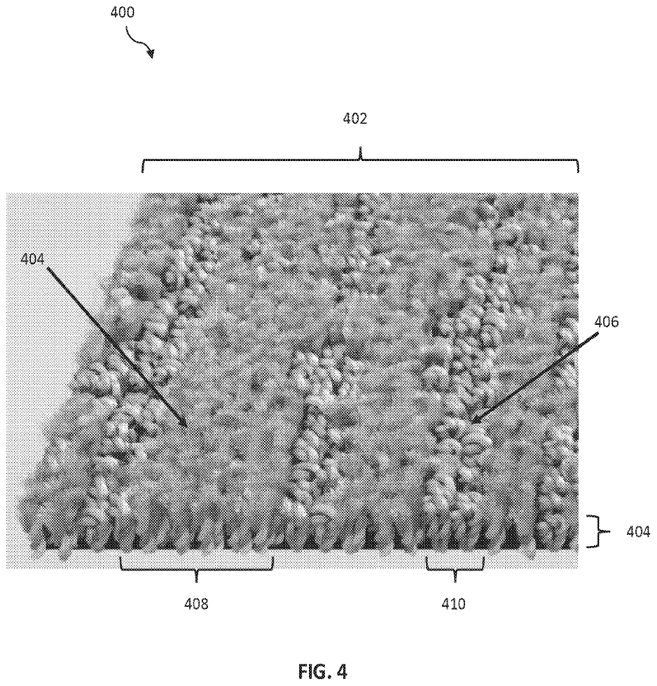

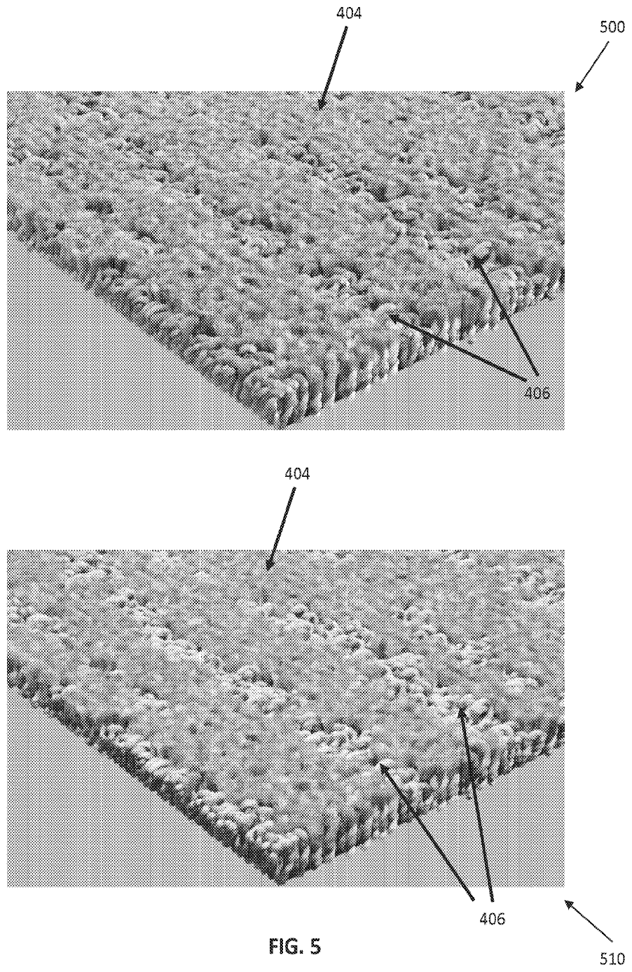

FIG. 4 illustrates an example of a portion of a simulated carpet 400 in an isometric view. The simulated carpet 400 has a different appearance on the top of the carpet 402 depending on whether the top section has cut pile 404 or loop pile 406. The figure's isometric display includes how the carpet appears from the edge 404. The edge/side of the carpet 404 also displays the different appearance between cut pile 408 and loop pile 410, so that the user can observe the differences not just from the top down but also from the side. FIG. 5 illustrates a simulation of a piece of carpet with two different types of illumination, also in isometric view. The upper portion of FIG. 5 shows a simulated carpet portion with top down illumination 500—the light source is directly above the carpet. The lower portion of FIG. 5 illustrates a simulated carpet portion with angled lighting 510—the light source is at an angle less than perpendicular to the plane of the carpet. The angled lighting makes the portion of the carpet with the looped pile 406 appear much brighter than the portion with the cut pile 404 for this particular type of yarn. For yarns with other material or optical characteristics (e.g., for yarns with different colors) the brightness of the type of pile (loop or cut) may be quite different even with the same illumination scheme. In the example shown in FIG. 5, with top down lighting, the apparent brightness is similar between the two types of pile, although the texture is still significantly different. In contrast, the angled lighting highlights the difference in reflected light between the loop pile and the cut pile. Other various angles and levels of illumination can be used based upon the desired view. In an embodiment, it is possible to include a script so that when the descriptor file is sent to the rendering engine, the simulated carpet is displayed under more than one type of illumination (e.g. direct illumination under different angles) or with more than one type of light (e.g., different color light, different intensity, or a different ratio of diffuse and direct illumination)

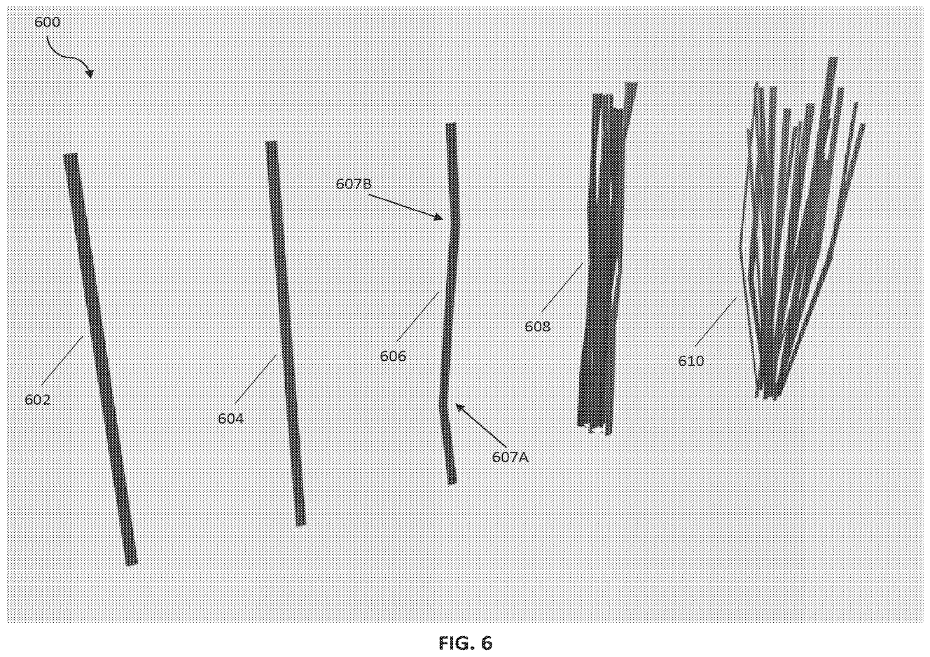

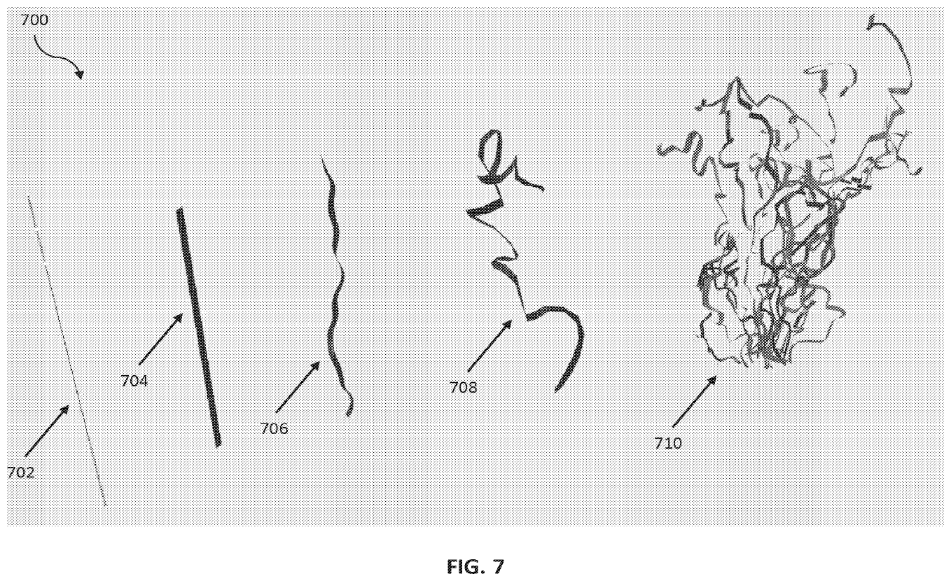

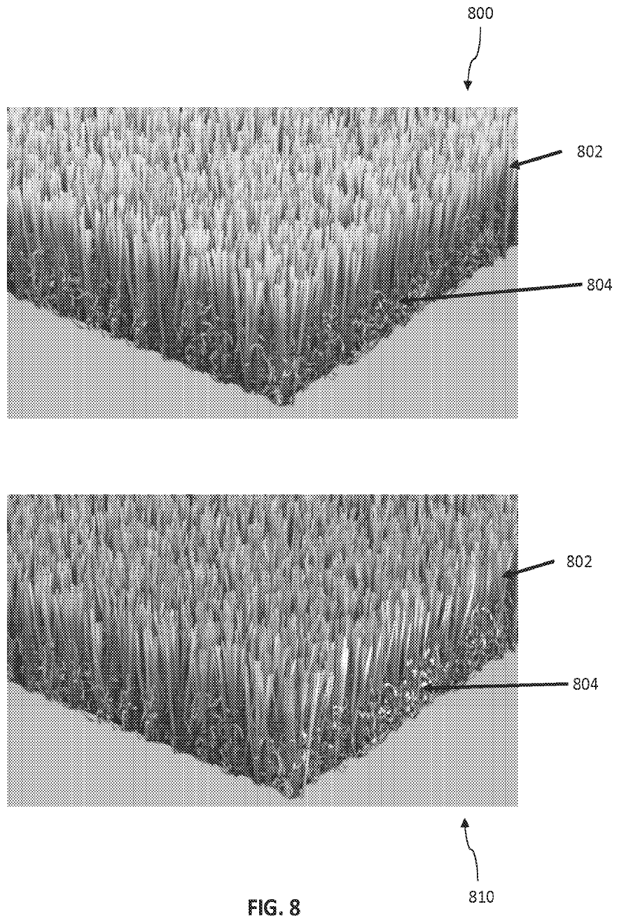

FIGS. 6-8 illustrate a process for simulating an artificial turf which is comprised of both simulated blades of grass (FIG. 6) and simulated pieces of thatch (FIG. 7). An example of a fully simulated piece of turf is shown in FIG. 8 under different illumination conditions. In creating a simulated blade of grass, the grass creation/simulation process 600 is similar to the method used for the creation of a simulated cut pile with yarn, but instead of using a single elongated cylinder as the basis for a single strand/filament, a flat planar object 602 is used instead—a long, thin rectangle. When using a two-dimensional object, there is more room for variation since the object can vary in total length, in total width, or even have variable widths at different locations along the length. While a flat object can also bend over two different perpendicular axes in both 2D and 3D, folding in 3D has different resulting effects. An example of a second simulated blade of grass is shown at 604, which may also have a different width and also may have a different color or a color variation along the length. A single blade with two kinks/folds/bends is shown at 606, but any number of bends may be simulated. However, in an aspect, between 4 to 8 different single blades of grass is sufficient to break up the uniformity of the blades. For example, a parent+children approach with at least 8 parent blades can be more than enough to form a clump. The first bend 607A and the second bend 607B bend have angles in opposite directions so that the overall direction of the blade of grass does not vary too much from a straight line. In an embodiment, constraints on the bends are imposed so that the planar object 602, 604 may more closely resemble an actual blade of grass. A group of such simulated blades is shown clumped together at 608 (bunched closely together and largely parallel) and at 610 (not parallel but diverging—bottoms bunched together and tops spread apart). These groups of simulated blades 608, 610 can have blades of different colors, can have color vary along their length, can have variable angles of displacement from adjacent blades, and can have variable lengths. In the two examples 608, 610 shown in FIG. 6, the second example 610 shows how the bottoms of the simulated blades are located very close together and the tops are more widely displaced. The second example 610 also has a greater length variation (a larger difference between the maximum blade length and the minimum blade length) and a greater dispersion of the tops of the blades than does the first example 608. In the first sample simulation of grass blades 608, eight blades are simulated. In the second sample 610, approximately 15 blades are simulated. Depending on the desired turf simulation different numbers of blades may be used to form a group or clump. In an embodiment using the parent and child simulation model, to more accurately simulate turf, all of the blades may considered parents which results in more complex calculations than for the equivalent example single tuft of yarn for a regular carpet shown in FIG. 3. For the example piles shown in FIG. 3, only two parent filaments 304 are required with the remaining filaments shown at 310 considered children of the two parents 304. For the simulation of turf, however, each blade of the clump 308, 310 may be fully simulated as a parent.

The bends in the blades of grass may be limited to a particular in number and the angles of the bends may also be limited to angles near a certain value (e.g., ±15 degrees from straight). In theory there is no limit to the number of kinks in a blade, however in an embodiment, between 1 and 10 kinks for a single blade of grass is usually sufficient to break up the uniformity of the blades, and preferably between 4 to 6 kinks. The blades of grass may also only bend along one axis-the axis perpendicular to the length of the blade. In an example, the grass blades may have 4 or fewer bends and the angles of the bends may be between 135 degrees and 225 degrees. In another example, the bends for the grass blades may have a narrower set of angles, such as 180°±20°, or ranging from 160 degrees to 200 degrees. While being a 2D object, the blades can in principle bend along two axes. In an embodiment, their actual bends may be limited to be over axes perpendicular to the length of the blade. In an embodiment, the angular displacement may be from a tangential calculation of a parent strand, if any, and may move slightly in either the X or Y directions.

In an embodiment, if there is more than one bend in a blade of grass, then the next bend moving up from the bottom of the blade may be required to have a bend which is opposite in direction to the first blend. For instance, if a blade of grass has three bends and the first bend angle is less than 180 degrees, then the second bend angle may be required to be greater than 180 degrees, and the third bend angle may again be required to be less than 180 degrees, so that the blade of grass does not coil in around itself. In an embodiment, the locations of the bends in the grass can be random or may be chosen to occur at selected locations only. In an alternative embodiment, this alternating bend rule is not used, but the total amount of angular displacement for a blade of grass at any point on its length must be less than a predetermined value. In such an embodiment, the greatest angle that any portion of the blade of grass may have relative to its initial plane at the bottom of the blade must be less than such a predetermined value. In another embodiment, the number of bends or kinks to simulate a blade of grass may be limited to fewer than a set number, for instance, 10 or fewer kinks/bends.

FIG. 7 illustrates an exemplary process 700 of forming a piece of thatch which may be intermingled with the clumps of grass blades for simulating turf. The thatch simulation/formation process 700 starts with forming a line at 702. The line is modified into a long rectangle/planar object at 704, similarly to the process for simulating a blade of grass. In the instance of thatch, the width may be narrower than for the blade of grass and the length may be longer, but either dimension may be varied according to the preference of the designer or user. In an embodiment, the length and width of the thatch are the same as, or nearly the same as, the length and width of the blades of grass. Unlike for the simulation of a blade of grass, however, the thatch generally has many more bends and kinks as shown at 706 (moderately bendy piece of thatch) and 708 (very bendy piece of thatch). Note that the thatch examples 706 and 708 show many more bends than do the equivalent blades of grass 606 (no bends) and 608 (two bends) from FIG. 6. Placing several pieces of thatch (e.g., very bendy thatch) together is illustrated at 710. Note that the constraints for bending may be quite different for a piece of thatch than for a blade of grass. For example, the very bendy thatch 708 coils about itself in a manner than is not permitted for a blade of grass. As for the blades of grass, the pieces of thatch may also vary in overall color as well as may have a color variation along their length. Due to the greater number of bends, some of the pieces of thatch may coil around each themselves (e.g. sample thatch 708) or around other pieces of thatch as shown at 710 and so appear rather different than the largely straight blades of grass.

The bends in the thatch may be greater in number than the bends in a blade of grass, but may also be located at randomly assigned locations along the length of the piece of thatch. In addition, the constraints on the angles of the bends each piece of thatch may be different than the constraints on these angles for a blade of grass. In an embodiment, the angles for the bend in a piece of thatch do not need to alternate the direction of the bend along the length of the piece of thatch. (As noted elsewhere in this disclosure, the grass blades may have a bend angle of less than 180 degrees followed by a bend angle greater than 180 degrees or a bend angle of greater than 180 degrees being followed by a bend angle of less than 180 degrees.) Thus, a piece of thatch may form coils or bend over upon itself. In an embodiment, a piece of thatch may have bends over two axes rather than along a single axis, as for some examples of the blades of grass. The thatch may bend over an axis which is parallel to the length and also may bend over an axis perpendicular to the length. In addition to simulating simple thatch and grass, logos, lines, or other markers can be added to the simulation without affecting the underlying simulated material properties of the grass blades or of the thatch pieces. Thus, it is possible to easily simulate adding a logo or image to the simulation of the full turf, as such an addition does not have an impact on the turf simulation.

FIG. 8 illustrates two isometric views of an example 3D simulated turf. The turf is illuminated from the top for sample 800 (illumination directly normal to the surface) and is illuminated from an angle off to the side for sample 810. Both samples illustrate how the clumps of simulated grass blades 802 are intermingled with thatch 804 at the base of the clumps of blades of grass. The top-illuminated sample 800 also shows how the tops of the simulated blades of grass appear much brighter than for the angle-illuminated sample 810. Note that the clumps of grass may extend well above the thatch, which is deeper into the simulated turf.

### Computer Hardware

The present systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

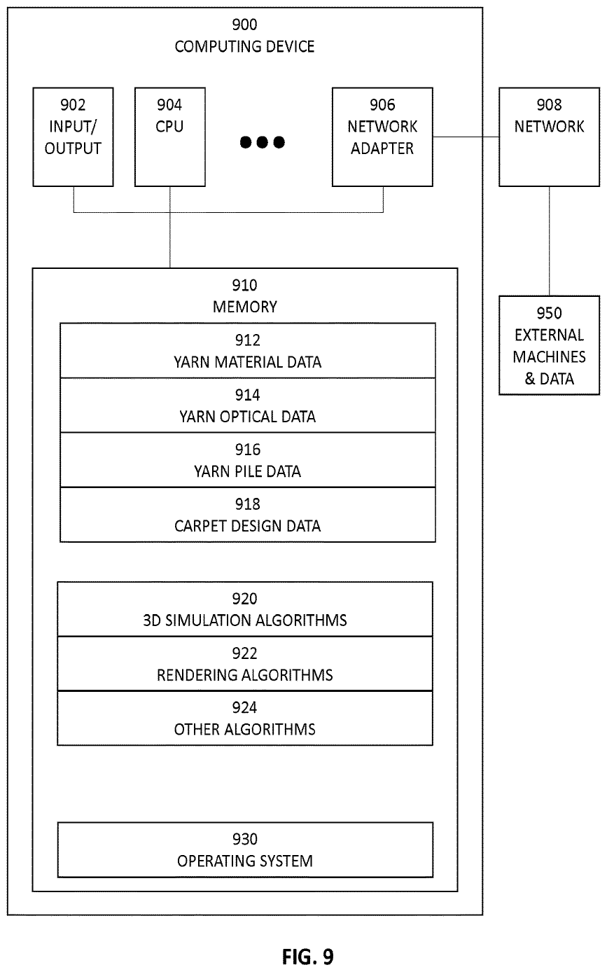

FIG. 9 illustrates a computing device 900 as it relates to the present disclosure. The computing device 900 may, for example, perform calculations, execute routines and algorithms, process data, communicate with other devices via a network, and display results. For example, a computing device 900 may comprise a processor or CPU 904, a network adapter 906 for communication with a network 908. The processor 904 may also comprise multiple processors working together or may comprise remotely connected processors with some processors performing tasks locally and other processors performing tasks remotely. The network 908 may connect the computing device 900 to external data sources (e.g. a yarn database) or to other machines (e.g., a tufting machine) 950. The computing device may comprise an input/output device 902. Such an input/output component 902 may be an input device, an output device, or both and the computing device 900 may have several such components. Example input devices 902 include a keyboard, a mouse, a microphone, a touchpad, a joystick, and the like. Example output devices 902 include a display, a speaker, a haptic feedback device, and the like. The computing device 900 may further comprise memory 910 or a computer readable storage medium 910. In the computer memory 910 may reside instructions for carrying out the methods and techniques described elsewhere in this disclosure. The computer memory 910 may also comprise an operating system 930 for control of the various parts and components of the computing device 900. The memory 910 may also store data, for example yarn material data 912, yarn optical data 914, yarn pile data 916, and carpet design data 918. The memory 910 may also comprise algorithms such as 3D simulation algorithms 920, rendering algorithms 922, or other algorithms 924.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device 950 via a network 908, for example, the Internet, a local area network, a wide area network and/or a wireless network. The network 908 may comprise copper transmission cables, optical transmission fibers, wireless transmission, routers, firewalls, switches, gateway computers, and/or edge servers. A network adapter card or network interface 906 in each computing/processing device 900 receives computer readable program instructions from the network and forwards the computer readable program instructions for storage in a computer readable storage medium within the respective computing/processing device.

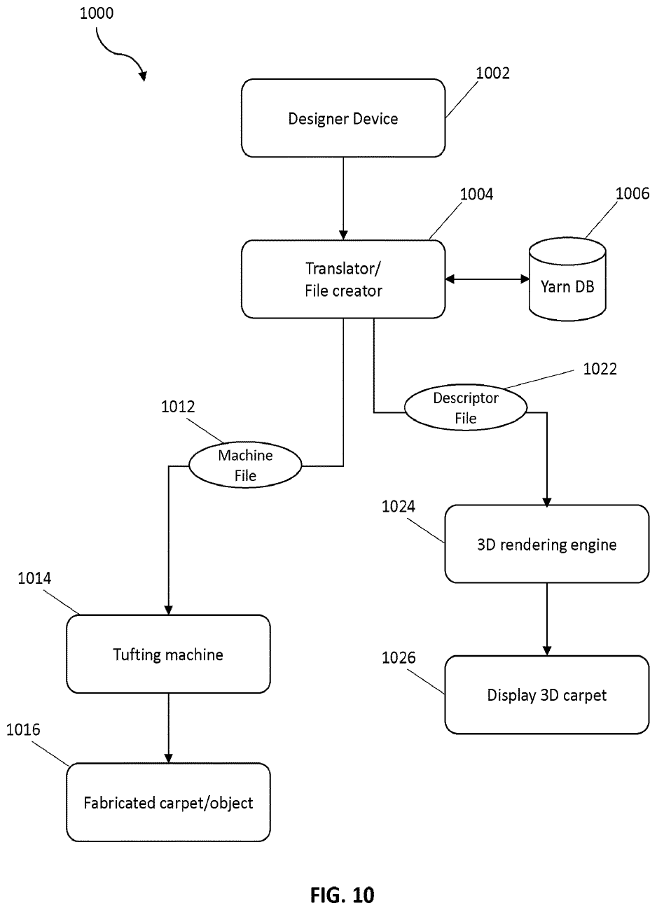

FIG. 10 shows an alternative example of the methods described herein. A system 1000 for producing a 3D simulation of a soft surface may comprise several different machines. In an embodiment, the system may comprise a designer device 1002 as well as a tufting machine 1014 and a 3D rendering engine 1024. The tufting machine 1014 may produce a carpet 1016 or other soft surface object. The tufting machine 1014 may receive a machine file 1012 which comprises instructions for fabricating a carpet, as described elsewhere in this disclosure. Analogously the 3D rendering engine 1024 may display a 3D simulation of a carpet 1026. The rendering engine 1024 requires a descriptor file 1022. As noted elsewhere in this disclosure the descriptor file may comprise a 2D representation of a carpet and also comprise, for example, the selection of a particular type of model for modelling or simulating the carpet in all three dimensions. The descriptor file 1022 may also comprise particular parameters used in the model or simulation. For example, the descriptor file may comprise an upper bound and a lower bound on the height of pile in a carpet, along with a distribution of pile height between these bounds. In an example, the descriptor file may comprise constraints on the angular bends a filament may have for a turf simulation.

In an embodiment, this method may reduce the requirement that a particularly fast computer processor is needed to simulate the soft object in three dimensions in a short amount of time. In an embodiment, the method may reduce the large memory requirements of a computer when performing three dimensional simulations. In an embodiment, all the operations of this method may be performed in a single device, but in other embodiments, different steps may be performed on different devices. For example, the carpet design may be performed on a designer device 1002, for example a designer's desktop computer. The carpet design may be submitted to a creation/translation device 1004. The translator 1004 may access a yarn database 1006 to retrieve the material or optical properties of a particular yarn. The translator 1004 may produce multiple files. For example, the translator my produce a machine file 1012 for a particular tufting machine 1014. Naturally, a different tufting machine may require a different type machine file due to differences in the types of tufting machines. The translator 1004 may also produce a descriptor file 1022 for use in simulating and displaying the carpet through the use of a 3D rendering engine 1024. The 3D carpet simulation may be displayed 1026 and evaluated prior to making a decision to fabricate the carpet. In an example, the 3D rendering engine 1024 may use a specially built computer with more memory and a faster processor (or faster processors) than a standard PC. In an example, the rendering may occur remotely from the design device, from the translator, and also from the display. In an example, a carpet may be designed at a first location, the 3D rendering may be performed at a second location, and the resulting 3D simulation be displayed at yet a third location. In this manner, computer resources may be conserved by employing a single faster computer rather than having to replicate such a rendering computer in multiple locations.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network 908, including a local area network (LAN) or a wide area network (WAN), or the connection may be made to an external computer 950 (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or that carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

We claim:

1-12. (canceled)

13. A method for simulating carpet in three dimensions comprising the steps of:
receiving parameters for modeling of a yarn;
modeling a tuft of the yarn using the received parameters;
based on the modelled tuft of the yarn, creating a descriptor file for a carpet;
submitting the descriptor file to a rendering engine,
wherein the descriptor file comprises a selection of a model from the rendering engine, and
wherein the model from the rendering engine comprises a parent and children model for filament modeling;
simulating a plurality of yarns based on a yarn texture, a yarn color, a pile height, a pile type, or a user preference from the received parameters; and
displaying the simulated carpet.

14. The method of claim 13, wherein the rendering engine is Blender.

15. The method of claim 13, wherein pile heights of different filaments of a yarn tuft are randomly distributed between a minimum height and a maximum height.

16. The method of claim 13, wherein the yarn is multi-ply yarn.

17. The method of claim 13, wherein the children of the parent filament are displaced from the parent filament in an X direction and a Y direction from the parent filament and the children filaments mimic the parent's modeled behavior.

18. The method of claim 13, wherein the simulated carpet is a simulated turf.

19. The method of claim 18, wherein the simulated turf comprises simulated blades of grass and simulated pieces of thatch.

20. The method of claim 19, wherein the simulated blades of grass have constraints on angles of bends and wherein the simulated pieces of thatch have no constraints on the angles of the bends.

21. The method of claim 19, wherein the simulated pieces of thatch may bend along an axis parallel to a length of the thatch and the simulated pieces of thatch may bend along an axis perpendicular to the length of the thatch, and wherein the simulated blades of grass may only bend along an axis perpendicular to a length of the blade of grass.

22. A method for simulating carpet in three dimensions comprising the steps of:
receiving parameters for modeling of a yarn, wherein the yarn is multi-ply yarn;
modeling a tuft of the yarn using the received parameters;
based on the modelled tuft of the yarn, creating a descriptor file for a carpet;
submitting the descriptor file to a rendering engine; and
displaying the simulated carpet,
wherein the simulated carpet comprises a turf with simulated blades of grass and simulated pieces of thatch,
wherein the simulated blades of grass have constraints on angles of bends, and wherein the simulated pieces of thatch have no constraints on the angles of the bends.

23. The method of claim 22, wherein the rendering engine is Blender.

24. The method of claim 22, further comprising simulating a plurality of yarns based on a yarn texture, a yarn color, a pile height, a pile type, or a user preference from the received parameters.

25. The method of claim 22, wherein pile heights of different filaments of a yarn tuft are randomly distributed between a minimum height and a maximum height.

26. The method of claim 22, wherein the descriptor file comprises selection of a model and model parameters from Blender.

27. The method of claim 26, wherein the model comprises a parent and children model for filament modeling.

28. The method of claim 27, wherein the children of the parent filament are displaced from the parent filament in an X direction and a Y direction from the parent filament and the children filaments mimic the parent's modeled behavior.

29. The method of claim 22, wherein the simulated pieces of thatch may bend along an axis parallel to a length of the thatch and the simulated pieces of thatch may bend along an axis perpendicular to the length of the thatch, and wherein the simulated blades of grass may only bend along an axis perpendicular to a length of the blade of grass.

30. A method for simulating carpet in three dimensions comprising the steps of:
receiving parameters for modeling of a yarn;
modeling a tuft of the yarn using the received parameters;
based on the modelled tuft of the yarn, creating a descriptor file for a carpet;
submitting the descriptor file to a rendering engine, wherein the rendering engine is Blender and the descriptor file comprises selection of a model and model parameters from Blender; and
displaying the simulated carpet, wherein the simulated carpet comprises:
a turf having simulated pieces of thatch; and
simulated blades of grass,
wherein the simulated pieces of thatch may bend along an axis parallel to a length of the thatch and the simulated pieces of thatch may bend along an axis perpendicular to the length of the thatch, and wherein the simulated blades of grass may only bend along an axis perpendicular to a length of the blade of grass.

31. The method of claim 30, further comprising simulating a plurality of yarns based on a yarn texture, a yarn color, a pile height, a pile type, or a user preference.

32. The method of claim 30, wherein pile heights of different filaments of a yarn tuft are randomly distributed between a minimum height and a maximum height.

33. The method of claim 30, wherein the yarn is multi-ply yarn.

34. The method of claim 33, wherein the model comprises a parent and children model for filament modeling.

35. The method of claim 34, wherein the children of the parent filament are displaced from the parent filament in an X direction and a Y direction from the parent filament and the children filaments mimic the parent's modeled behavior.

36. The method of claim 30, wherein the simulated blades of grass have constraints on angles of bends and wherein the simulated pieces of thatch have no constraints on the angles of the bends.
